(19) United States
(12) Patent Application Publication
(10) Pub. No.: US 2025/0153101 A1
(43) Pub. Date: May 15, 2025

(54) AIR CLEANING DEVICE, CONTAINMENT, AND USE THEREOF

(71) Applicant: SKAN Deutschland GmbH, Görlitz (DE)

(72) Inventors: Benjamin Eggert, Zittau (DE); Gregor Hommes, Wachtendonk (DE); Martin Novák, Binningen (CH)

(73) Assignee: SKAN Deutschland GmbH, Görlitz (DE)

(21) Appl. No.: 18/941,094

(22) Filed: Nov. 8, 2024

(30) Foreign Application Priority Data
Nov. 10, 2023 (EP) 23209186.8
Feb. 22, 2024 (DE) 102024105068.3

(51) Int. Cl. B01D 53/86

(52) U.S. Cl. CPC B01D 53/8675; B01D 2255/2073; B01D 2257/106; B01D 2257/553

(57) ABSTRACT

An air cleaning device (1) in a containment, especially isolator, is provided which includes a catalyst (2) which is disposed on a surface of a porous support (3) and is covered by a grid, preferably on both sides, in a flow cross section (5). The air cleaning device is used for elimination of hydrogen peroxide. A containment in which the air cleaning device (1) is incorporated into the circulation circuit of the containment is also provided.

### CROSS-REFERENCE TO RELATED APPLICATIONS

This application claims priority from European Patent Application No. 23209186.8, filed Nov. 10, 2023, and German Patent Application No. 10 2024 105 068.3, filed Feb. 22, 2024, both of which are incorporated herein by reference as if fully set forth.

### TECHNICAL FIELD

The invention relates to an air cleaning device for a containment, especially an isolator, comprising a catalyst disposed on a surface of a porous support.

In a further aspect, the invention relates to a containment comprising such an air cleaning device.

In a further aspect, the invention relates to the use of an air cleaning device in a containment.

### BACKGROUND

For decontamination purposes, hydrogen peroxide (H₂O₂) and ozone (O₃) is often evaporated and/or nebulized in an isolator or introduced into the isolator in some other way. Alternatively, electron beams (e-beams) or UV rays are used for decontamination, which give rise to ozone as a by-product. After the decontamination process has ended, these substances must be removed again from the space to be decontaminated for reasons of personal protection and product protection. With the aid of a catalyst, the intention is to degrade the substances to such an extent that no risk to the health of operating personnel exists after the decontamination.

Air cleaning devices for detoxification of gases are known from the prior art, and widely used. A wide variety of different catalysts with usually pulverulent or spherical catalyst material in the form of bulk material is used here. Such catalysts use manganese oxide inter alia. However, the manganese oxide is usually generally used here in granular form. A disadvantage here is that the necessary compaction process means that homogeneity and reproducibility of the porosity of a bed cannot be assured. Moreover, the vibrations of the bed of bulk material results in the possibility of subsequent compaction, which, in the case of beds through which the flow passes vertically, can lead to altered bed height and porosity, and, in the case of beds through which the flow passes horizontally, can additionally lead to gaps in the upper region of the bed of bulk material. For that reason, the edge zones of a fixed bed catalyst should be generously shielded. In order to assure process reliability and compensate for the reduced effective cross section with uniform cross section of the fixed bed catalyst, it is therefore necessary to increase the height of the bed of bulk material. This disadvantageously leads to a high pressure drop in the flow through the fixed bed catalyst, i.e. reduced energy efficiency.

### SUMMARY

It is the object of the invention to create an alternative to the constructions customary to date.

The stated object is achieved in accordance with the invention by an air cleaning device with one or more of the features disclosed herein. In particular, the stated object is thus achieved in an air cleaning device for a containment of the type described at the outset in that in accordance with the invention the catalyst is covered preferably by at least one grid in a flow cross section. It is thus possible that a gas and/or a liquid can flow through the catalyst. What is thus provided is a presentation form of the catalyst which is durable in use and does not undergo compaction and is readily processible and is also usable, for example, in setups where a bulk material catalyst has to be prevented from trickling out. The optional coverage with a grid has the advantage of effective touch protection or spacer in relation to the catalyst substances that are harmful to health.

In an advantageous configuration, it may be the case that the porous support has been created by sintering a preferably organic foam material soaked with a ceramic solution. During the sintering, the ceramic solution is consolidated, and the organic foam material, for example, is broken down or disappears or sublimes, so as to give rise to an open-pore structure. This open-pore structure can form a large surface area for a catalyst through which flowability is and remains good by virtue of its open-pore character.

In this way, the production of dimensionally stable solid-state ceramic foam bodies is possible, which are adaptable to the respective desired geometric shapes. It is advantageous that the porous support has high fracture resistance and low intrinsic weight, and hence can be used without difficulty in isolators of different size and shape.

Examples of known foam materials include polyethylenes (PE), polypropylenes (PP), polytetrafluoroethylene (PTFE), polyvinylidene fluoride (PVDF). In addition, thermoplastic polyurethane (TPU), ethylene-vinyl acetate (EVA), polycarbonate (PC), polyamide (PA) and polyethersulfone (PES) are also used as base materials for the production of porous polymers.

In an advantageous configuration, it may be the case that the porous support consists of a mesh of irregular channels. The dwell time of the material flowing through the catalyst is thus increased, and hence a higher degradation rate of the gas and/or of the liquid in the catalyst is achieved.

In an advantageous configuration, it may be the case that the porous support consists of a mesh of branched channels. The dwell time of the material flowing through the catalyst is thus increased, and hence a higher degradation rate of the gas and/or of the liquid in the catalyst is assured.

In an advantageous configuration, it may be the case that the at least one grid has a mesh size that achieves touch protection of the catalyst. In a preferred embodiment, the grid has a mesh size of ideally between 6 mm and 10 mm, but not more than 12 mm. It is thus possible in the case of exchange or removal of the catalyst to prevent direct skin contact with the catalytically active coating which is harmful to health, and abrasion thereof.

In an advantageous configuration, it may be the case that the at least one grid has a thickness that achieves touch protection of the catalyst. In a preferred embodiment, the grid has a thickness of not more than 1.5 mm. It is advantageous when the grid is manufactured from four printed layers each of 0.25 mm and forms a kind of spacer layer from the catalyst. It is thus possible in the case of exchange or removal of the catalyst to prevent direct skin contact with the catalytically active coating which is harmful to health, and abrasion thereof.

In an advantageous configuration, it may be the case that the grid is formed of at least two layers. A three-layer grid structure is particularly favorable. It would theoretically also be possible to manufacture the grids in one layer. It is advantageous when the first layer is configured from a grid structure composed of equilateral triangles having side length 6-12 mm. In a likewise conceivable embodiment, the grid structure may be in square or hexagonal configuration. The first layer, owing to its geometric configuration, thus serves for stabilization and strength and hence as protection against deformation and compression. It is advantageous that the envisaged configuration of the grid structure is much easier to achieve by the 3D printing method.

It is advantageous when the second and third layers take the form of very fine layers and/or the two grids each cross at a 90° angle, for example such that they form a square mesh and/or a mesh having an edge length of 1-3 mm. In a likewise conceivable embodiment, the square mesh may be in single-layer form. It is advantageous when the fine grids have a permeability of 75% and a coverage of 25%; also conceivable would be a grid structure having a coverage of 50% or 90%, such that this mesh size results in touch protection without significant restriction of the gas and/or liquid flow through the grid. Other basic grid forms are also usable, for example with threefold or fivefold symmetry or irregular basic forms.

In an advantageous configuration, it may be the case that the at least one grid forms part of a housing of the catalyst. The housing is thus incomplete, such that a gas and/or a liquid can flow through the catalyst. It is advantageous when at least 50% of the housing takes the form of a grid.

In an advantageous execution, it may be the case that the housing consists of a grid base, a grid top and a wall. It is thus possible to insert the catalyst into the insulator with the aid of the housing. It is advantageous when the housing covers a small amount of the catalyst surface in order to achieve good cleaning efficiency here.

In an advantageous configuration, it may be the case that the at least one grid has been produced by an additive method. This enables formation of very fine structures with sufficient accuracy, such that unintentionally closed grid openings are avoidable. These could have an unfavorable effect on air permeability. Particularly fine structures, especially grid spacings, are advantageous in order to reliably rule out unintended touch contact.

It is advantageous when a fine grid (third layer) is first printed onto a flat surface, and then the next fine grid (second layer), for example rotated by 90°, is printed onto the latter, and finally a coarser grid (first layer), preferably with a different grid structure, for example composed of equilateral triangles. It is also possible to manufacture only the second and third layers or only the first and second layers in this way.

This procedure offers the advantage that a smooth outer layer is formed, which is utilizable firstly as sealing surface and secondly as reference for a milling machine. Layer-by-layer manufacture of the housing of the catalyst is advantageous, beginning with the outer finest layer, onto which the further layers and the frame are printed. In this case, the lowermost layer (for example third layer) is created with an elevated pressure, such that the exiting material from the print nozzle backs up a little at the surface and hence the line structure becomes somewhat thicker. In the subsequent layers, the printing operation is adjusted accordingly, such that no thickening arises here at the points of intersection of the grid structure. In the manufacture of the triangular grid layer, the connecting bars that form parallel to one fine grid are positioned such that the connecting bars of the triangular grid layer are superimposed on the grid bars of the fine support.

Subsequently, the grid top with the three layers is manufactured, where the fine ply on the outside is printed first here too. Bonding material, for example silicone, is introduced into the housing, and the catalyst is inserted. The grid top is then inserted after additional adhesive has been applied in the interspace between frame and catalyst and to the top side of the catalyst. With the aid of a milling machine, it is possible after the assembly to remove the excess material from the frame or the housing or to remove exuded adhesive residues, such that a sealing face is also possible on the other side. In this way, firstly, simple and inexpensive production of very fine grids and, secondly, very rapid individual size adjustment is possible.

The grid may consist, for example, of plastics, synthetic resins or metals, which are converted to the desired shape by powder-based melting, curing of synthetic resin or by extrusion.

Conceivable additive manufacturing methods include the following methods: electron-beam melting (EBM), fused deposition modeling (FDM), multijet modeling (MJM), polyamide casting, selective laser melting (SLM), selective laser sintering (SLS), space puzzle molding (SPM), stereolithography (SL) and binder jetting (BJ). The additive manufacturing method is preferably FDM 3D printing.

In an advantageous configuration, it may be the case that the at least one grid has at least two crossing arrays of bars that are especially arranged in separate layers. It is thus possible to create a relatively loose structure that firstly does not limit the flow of the gas and/or the liquid and secondly prevents direct contact with the catalyst.

In an advantageous configuration, it may be the case that the at least one grid has at least two plies of different mesh size. The different mesh size, as well as mechanical protection against pressure and deformations, additionally enables protection from contact.

In an advantageous configuration, it may be the case that the at least one grid is joined by a seal around the flow cross section. A tight seal is thus achievable in an installation situation that can prevent uncontrolled flow of contaminated air. It is advantageous when the edge of the housing is provided with an EPDM seal. This prevents the gas and/or liquid stream from escaping laterally from the catalyst, hence allowing the hydrogen peroxide or ozone not to be fully degraded.

In an advantageous configuration, it may be the case that a circumferential seal, for example the one already mentioned, is formed at a circumferential frame that preferably joins two grids.

For example, the seal material may consist of ethylene-propylene-diene rubber (EPDM) and polytetrafluoroethylene (PTFE).

For example, the joining frames may take the form of a housing. The walls of the frame are sensibly aligned to the height of the porous support, such that the frame is able to seal the porous support in a gastight manner as a housing, allowing the gas and/or the liquid to flow exclusively through the porous support in the region of the grid and hence to be sufficiently degraded.

In an advantageous configuration, it may be the case that the housing is composed of at least two parts, where each of the two parts has a respective grid. It is thus possible for the housing to be configured in accordance with the size of the catalyst and for the catalyst to be effectively embedded into the housing. Simple assembly is thus possible.

It is advantageous when the wall of the housing has a thickness of 1.5 mm±1.0 mm.

In another preferred embodiment, only one of the at least two grids (e.g. grid base or grid top) has the wall of the housing. Accordingly, the other component has merely a two-dimensional shape with a height of, for example, not more than 1.5 mm. The height of the wall on the other component is aligned at the height of the shaped ceramic foam body, since the housing is ultimately intended to enclose the whole shaped ceramic foam body in a gastight manner.

In an advantageous configuration, it may be the case that the housing is sealed off from the outside. It is thus not possible for gas and/or liquid to escape in an uncontrolled manner during the process, and effective degradation of the gas which is harmful to health and/or of the liquid which is harmful to health is enabled.

The seal is on at least one of the sides of the housing of the fixed bed catalyst and advantageously prevents insufficient degradation. This is because it prevents the initial gas and/or liquid flow from moving past the side of the catalyst housing and exiting before it is immersed into the catalyst and the hydrogen peroxide or ozone can be degraded. This advantageously prevents hydrogen peroxide or ozone, which are harmful to health, from getting round the shaped ceramic foam body.

For example, the seal may take the form of a flat seal or crown seal.

In an advantageous configuration, it may be the case that the catalyst is designed to break down hydrogen peroxide.

In an advantageous execution, the whole surface of the porous support is coated. Examples of useful catalytically active coating materials include metal oxides such as manganese(IV) oxide or manganese oxides in different oxidation states, and precious metals, for example platinum (Pt) or silver (Ag).

In an advantageous configuration, it may be the case that the support is formed from a ceramic material. It is thus possible to provide a rigid, open-pore, solid-state foam body, the porosity of which remains unchanged as the flow passes through it. In addition, the ceramic material has very low thermal conductivity, such that the degree of conversion by the coating is improved on account of the exothermic catalytic reactions.

In a further advantageous configuration, it may be the case that the support is formed from a metallic material.

Alternatively or additionally, for achievement of the stated object, the invention provides the features of the further independent claim directed to a containment, especially an isolator. In particular, for achievement of the stated object, in a containment, especially isolator, of the type described at the outset, it is thus proposed in accordance with the invention that the air cleaning device is disposed in a circulation circuit of the containment. It is thus possible to conduct the cleaning process within the isolator without penetration of harmful substances to the outside.

The circulation circuit may be characterized here, for example, by withdrawal, processing and recycling of a substance, especially a fluid, for example of the or a gas and/or the or a liquid.

In a preferred application of the invention, an air cleaning device of the invention is used in a containment, especially isolator, for elimination of hydrogen peroxide. It is thus possible that the H₂O₂ evaporated and/or nebulized for sterilization purposes and the O₃ formed and/or introduced as by-product are removed again from the sterilized space after the sterilization process. This prevents operating personnel from coming into contact with gases or liquids that are hazardous to health via waste air or on entry into the sterilized space.

### BRIEF DESCRIPTION OF THE DRAWINGS

The invention is now described in detail by a working example, but is not limited to the working example. Other working examples will be apparent by a combination of the features of single or multiple claims with one another and/or with single or multiple features of the working example.

The figures show:

FIG. 1 a three-dimensional overall view of the air cleaning device,

FIG. 2 a detail view of the front,

FIG. 3 an exploded diagram,

FIG. 4 a detail of the grid with equilateral triangles

FIG. 5 a further detail of the grid with transverse struts

FIG. 6 a further detail of the grid with longitudinal struts

FIG. 7 a detail of a longitudinal section with the frame,

FIG. 8 a further detail of a longitudinal section with the front grid,

FIG. 9 a detail of a cross section at the level of the rearmost grid,

FIG. 10 a detail of a cross section at the level of the grid disposed in front of the latter,

FIG. 11 a detail of a cross section at the level of the grid disposed in front of the latter,

FIG. 12 a detail of a cross section at the level of the support body,

FIG. 13 a detail of a cross section at the level of the grid disposed in front of the latter,

FIG. 14 a detail of a cross section at the level of the grid disposed in front of the latter,

FIG. 15 a detail of a cross section at the level of the final grid disposed in front of the latter, and

FIG. 16 a front grid in a further working example.

### DETAILED DESCRIPTION

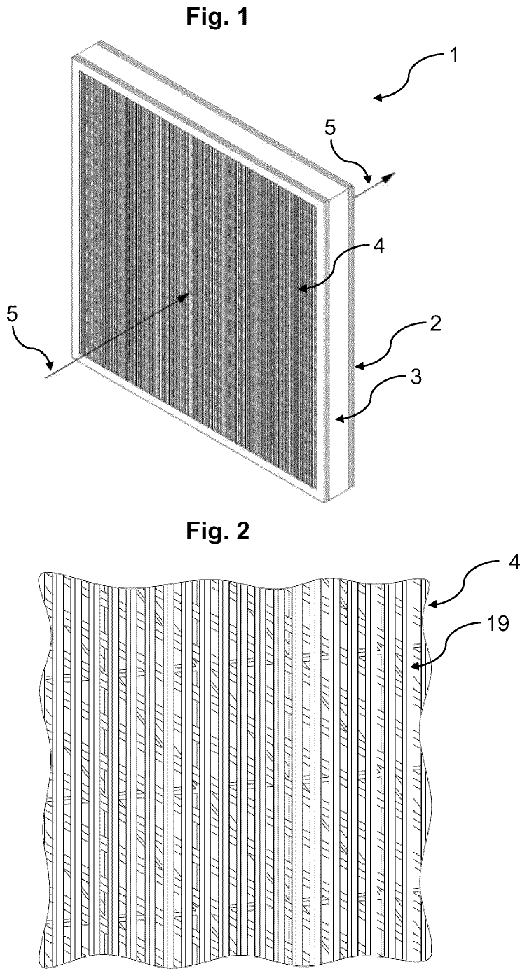

FIG. 1 shows a three-dimensional overall view of the inventive air cleaning device 1.

The air cleaning device 1 may be disposed, for example, in a circulation circuit of a containment and be used, for example, for elimination of hydrogen peroxide from the containment.

The air cleaning device 1 consists of a catalyst 2 which is covered on each side by a grid 4 in terms of its flow cross section 5.

The catalyst 2 consists of a porous support 3 provided with a catalytically active coating. The porous support 3 may have been produced, for example, from a ceramic and/or metallic material.

As catalytic coating, for example, the porous support 3 may have been coated with manganese oxide.

In an execution which is not shown, the porous support 3 is produced by sintering an organic foam material soaked with ceramic solution. During the sintering process, the ceramic solution solidifies and the organic foam material breaks down and disappears. This gives rise to a porous support 3 having a mesh of irregular and/or branched channels.

In a further working example, the porous support 3 has been produced as a metal foam.

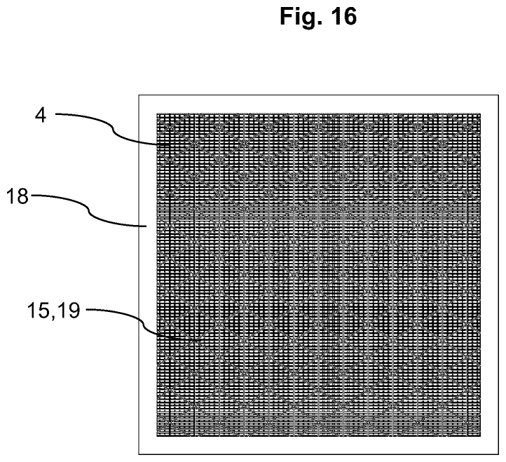

As shown in FIGS. 2 to 16, the catalyst 2 has been provided with a grid 4.

The grid 4 is manufactured, for example, by an additive method. As shown in FIG. 8, it may ideally be the case that the grid 4 consists of at least two layers. The mesh size 12 and/or thickness 13 of the grid 4 is/are, for example, designed such that there is no direct touch contact with the catalyst 2 and hence not with the substances hazardous to health either.

The grid 4 is part of a housing 6 of the catalyst 2. The housing 6 may consist, for example, of a grid base 7, grid top 8 and a wall 9.

FIG. 2 shows a detail view of the front with the grid structure and the different layers of the grid 4. For example, the grid 4 may be formed from different layers of different mesh size.

The working example of FIG. 2 shows a grid 4 of crossing arrays of bars arranged in separate layers. The arrangement in the example is of three crossing layers, but it is also conceivable that there are only one or two layers.

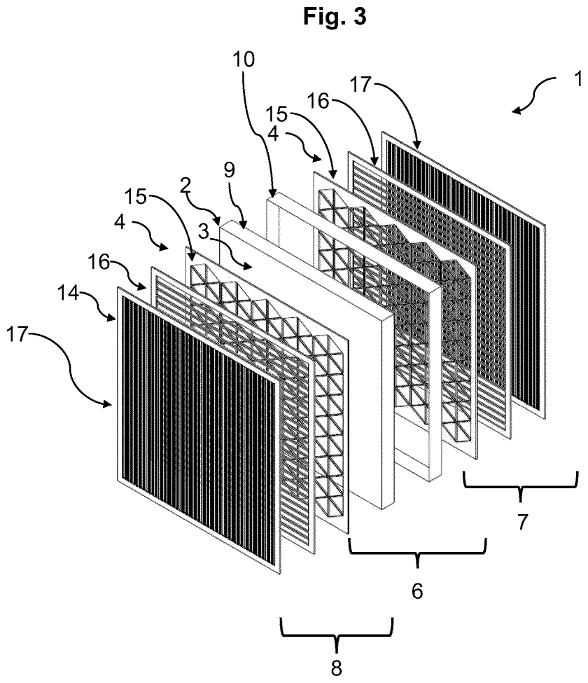

FIG. 3 shows an exploded view of the air cleaning device 1. The working example from FIG. 3 consists of a three-layer grid base 7, a catalyst 2, a grid top 8 and a wall 9. The grid base 7, the wall 9 and the grid top 8 form a kind of frame 11 for the catalyst 2. The grid base 7 and the grid top 8 consist of three layers having different grid structures.

The wall 9 may take the form of a frame 11, for example, in which the catalyst 2 can be inserted cohesively and is bonded to the grid base 7 and grid top 8. For example, a seal 10 may be formed in the frame 11. The seal 10 is intended to prevent escape of gas and/or liquid which are hazardous to health.

In a working example which is not shown, a seal 10 may be formed on the outside of the frame 11, such that no gas, which is harmful to health, and/or liquid can escape outside the catalyst 2.

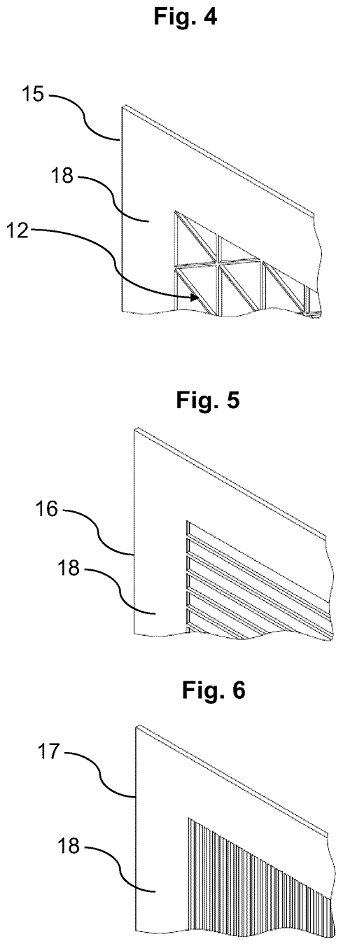

FIG. 4 shows a detail view of the grid 15 directly adjoining the catalyst 2. The grid 15 is formed by a grid structure composed of equilateral triangles.

FIG. 5 shows a detail view of the grid 16 with a grid structure having an array of bars. The bars are formed in horizontal direction.

A detail view of the grid 17 is shown in FIG. 6. The grid 17 likewise has an array of bars. However, the bars are aligned in vertical direction here. The grid structure of the grids 15 to 17 forms a touch guard 14 in order thus to prevent direct contact with the catalyst 2.

By comparison of FIG. 4 with FIG. 5, it is clear that the bars of the grid 16 do no more than cross the bars of the grid 15, such that there are only point contacts between the grids 15, 16.

In a further working example, the grids 16 (FIG. 5) and 17 (FIG. 6) are switched around, such that individual bars of the grid 16 become coincident with particular bars (for example the bars running in a straight line from one edge to the opposite edge). This can be used for stabilization of the grid 17 on the grid 15.

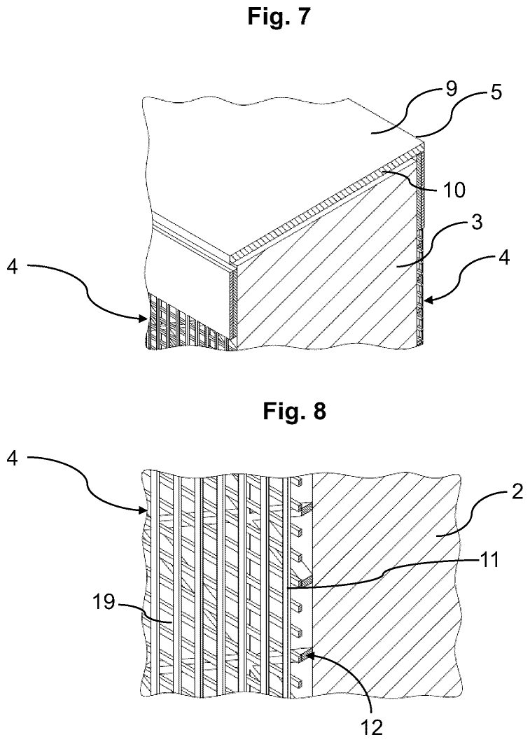

FIG. 7 shows a further working example of the air cleaning device 1. The porous support 3 is embedded in the middle and is covered by one grid 4 each at the top and bottom sides. At the lateral edges, the catalyst 2 is provided with a closed wall 9, such that the gas and/or liquid can flow through only in the flow cross section 5. A seal 10 seals the gaps between the porous support 3, the wall 9 and the grid base 7 and grid top 8 in a gastight manner. This achieves the effect that the gas and/or liquid is passed through the catalyst 2 in a controlled manner, and no gas, which is hazardous to health, and/or liquid can escape at the side of the housing 6.

FIG. 8 shows a further detail of a longitudinal section with the front grid. A three-layer grid 4 is present on the catalyst 2, which is designed to degrade hydrogen peroxide, for example. The lowermost grid 15 lying atop the catalyst 2 differs both in mesh size 12 and in thickness 13 from the further grids. In the middle 16 and uppermost grids 17, the bars are arranged at a 90° angle to one another, such that they form a fine-mesh grid structure.

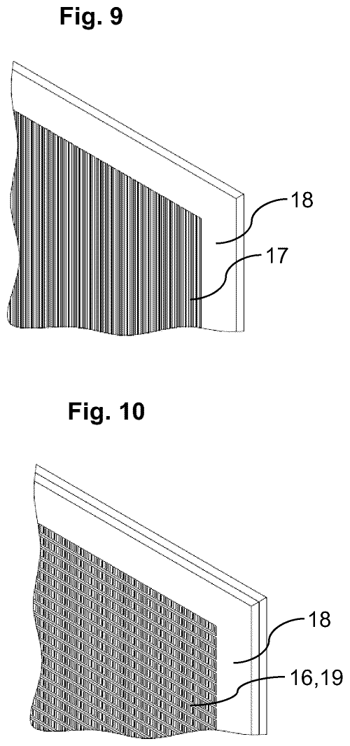

FIGS. 9 to 15 that follow show the construction of an air cleaning device 1 in illustrative form. The individual figures hereinafter each show detail views of the construction of the working example. In an illustrative configuration, the housing 6 has a grid base 7, a grid top 8 and a wall 9.

FIG. 9 of the working example shows a detail of a cross section at the level of the rearmost grid 17. The grid 4 may take the form, for example, of part of the housing 6 of the catalyst 2. The grid 17 has a uniformly arranged number of longitudinal bars 17, and a circumferential edge 18.

FIG. 10 of the working example depicts a detail at the level of the grid 16 disposed in front. The grid 16 is likewise formed with bars and a circumferential edge 18. However, the bars are arranged in horizontal direction, such that the bars of the grid 17 and of the grid 16 which is disposed in front of the latter cross at a 90° angle and form a square mesh 19.

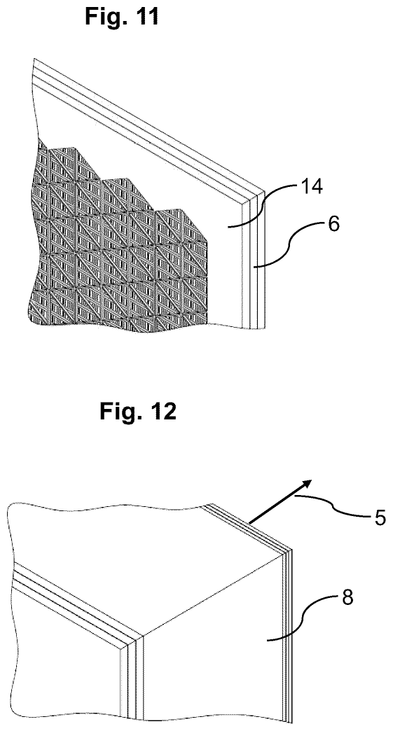

FIG. 11 of the working example depicts a detail at the level of the grid disposed in front. The grid in FIG. 11, together with the grids in FIGS. 9 and 10, forms the grid base 7. The grid 4 of the working example in FIG. 7, which is disposed in front, has a structure composed of different equilateral triangles. By comparison with the grids shown from FIGS. 8 and 9, the grid 4 from FIG. 11 has significantly coarser meshes and serves preferably for stabilization.

FIG. 12 of the working example shows a further detail at the level of the support body. The working example shows the closed wall 9 of the housing 6.

In a further working example, which is not shown, the housing 6 may be in a two-part configuration, and each part may have a grid 4. One conceivable configuration may also be that one of the grid bases 7 and/or the grid top 8 is bonded to the wall 9 and/or the grid base 7 and/or the grid top 8 are configured separately.

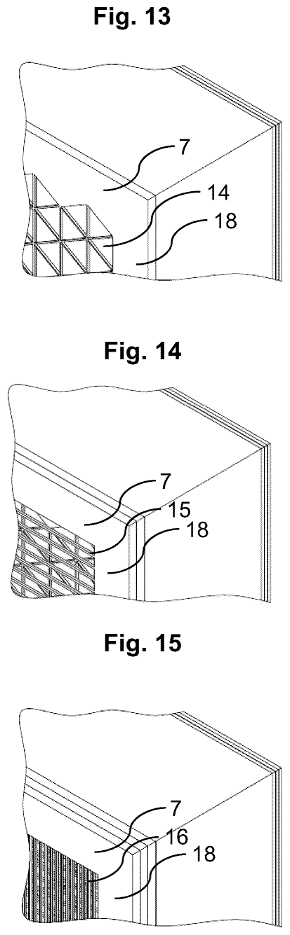

FIGS. 13 to 15 show the grid top 8.

FIG. 13 of the working example depicts a detail of a cross section at the level of the grid disposed in front. The grid 15 disposed in front is, for example, part of the grid top 8 and likewise has the structure of equilateral triangles.

FIG. 14 of the working example depicts a detail of a cross section at the level of the grid disposed in front. The grid 16 has uniformly arranged bars in horizontal direction and a circumferential edge 18.

FIG. 15 of the working example depicts a detail of a cross section at the level of the final grid disposed in front. The grid 17 of the grid top is of identical design to the grid 17 from FIG. 9 and has a uniformly arranged number of vertical struts and a circumferential edge 18.

FIG. 15 depicts a grid 4 in a further working example in a top view. The grid 4 firstly has a grid structure composed of equilateral triangles 15, and also a grid structure composed of a fine square mesh 19. The grid 4 has likewise been provided with a circumferential edge 18.

The invention relates to an air cleaning device 1 in a containment, especially isolator, having a catalyst 2 which is disposed on a surface of a porous support 3 and is preferably covered by a grid 4 on both sides in a flow cross section 5. The invention is used for elimination of hydrogen peroxide. The invention further relates to a containment in which the air cleaning device 1 is incorporated into the circulation circuit of the containment.

### LIST OF REFERENCE NUMERALS

1 air cleaning device
2 catalyst
3 porous support
4 grid
5 flow cross section
6 housing
7 grid base
8 grid top
9 wall
10 seal
11 frame
12 mesh size
13 thickness
14 contact guard
15 grid with equilateral triangles
16 grid with horizontal bars
17 grid with vertical bars
18 circumferential edge
19 square mesh

1. An air cleaning device (1) for a containment, the air cleaning device comprising:
a porous support (3);
a catalyst (2) disposed on a surface of the porous support (3); and
at least one grid (4) that covers the catalyst (2) in a flow cross section (5).

2. The air cleaning device (1) as claimed in claim 1, wherein the porous support (3) is formed of a sintered foam material soaked with a ceramic solution.

3. The air cleaning device (1) as claimed in claim 1, wherein the porous support (3) forms a mesh of at least one of irregular or branched channels.

4. The air cleaning device (1) as claimed in claim 1, wherein the at least one grid (4) has t least one of a mesh size (12) or a thickness (13) that provides for touch protection (14) of the catalyst.

5. The air cleaning device (1) as claimed in claim 1, wherein the grid (4) is formed of at least two layers.

6. The air cleaning device (1) as claimed in claim 1, wherein the at least one grid (4) forms part of a housing (6) of the catalyst (2).

7. The air cleaning device (1) as claimed in claim 1, wherein the housing (6) is formed of a grid base (7), a grid top (8) and a wall (9).

8. The air cleaning device (1) as claimed in claim 1, wherein the at least one grid (4) comprises an additive manufacture part.

9. The air cleaning device (1) as claimed in claim 1, wherein the at least one grid (4) has at least two crossing arrays of bars that are arranged in separate layers.

10. The air cleaning device (1) as claimed in claim 1, wherein the at least one grid (4) has at least two layers of different mesh size (12).

11. The air cleaning device (1) as claimed in claim 1, wherein the at least one grid (4) is joined by a seal (10) around the flow cross section (5).

12. The air cleaning device (1) as claimed in claim 1, wherein the at least one grid comprises at least two of the grids, and a circumferential seal (10) is formed at a circumferential frame (11) that joins two of the grids (4).

13. The air cleaning device (1) as claimed in claim 1, wherein the at least one grid (4) forms part of a housing (6) of the catalyst (2), and the housing (6) includes at least two parts, and each of the two parts has a respective one of the grids (4).

14. The air cleaning device (1) as claimed in claim 13, wherein only one of the at least two grids (4) includes a wall (9) of the housing (6).

15. The air cleaning device (1) as claimed in claim 13, wherein the housing (6) is sealed off from outside.

16. The air cleaning device (1) as claimed in claim 1, wherein the catalyst (2) is adapted to break down hydrogen peroxide.

17. The air cleaning device (1) as claimed in claim 1, wherein the support (3) is formed from of at least one of a ceramic or a metallic material.

18. A containment, comprising the air cleaning device (1) as claimed in claim 1, and the air cleaning device (1) is disposed in a circulation circuit of the containment.

19. The containment of claim 18, wherein the air cleaning device (1) is configured for elimination of hydrogen peroxide from the containment.

20. The containment of claim 18, wherein the containment comprises an isolator.
